(19) United States
(12) Patent Application Publication
(10) Pub. No.: US 2012/0125342 A1
(43) Pub. Date: May 24, 2012

(54) FILTERING FACE-PIECE RESPIRATOR HAVING SUPPORT STRUCTURE INJECTION MOLDED TO FILTERING STRUCTURE

(75) Inventors: Yonas Gebrewold, Woodbury, MN (US); Michael K. Domroese, Woodbury, MN (US); Dean R. Duffy, Woodbury, MN (US); Dwayne D. Daugaard, Hudson, WI (US); Nhat Ha T. Nguyen, Woodbury, MN (US); David M. Blomberg, Lino Lakes, MN (US); Denise A. Barrera, Oakdale, MN (US)

(73) Assignee: 3M Innovative Properties Company

(21) Appl. No.: 12/949,963

(22) Filed: Nov. 19, 2010

(51) Int. Cl. A62B 23/02; B29C 45/14

(52) U.S. Cl. 128/206.12; 264/259

(57) ABSTRACT

A filtering face-piece respirator 10 that comprises a mask body 12 and a harness 14. The mask body 12 includes a supporting frame structure 16 and a filtering structure 18. The frame structure is injection molded onto the filtering structure 18 such that the frame structure 16 becomes bonded to the filtering structure 18. A mask body having such a support structure allows the filtering structure to follow its configuration closely, providing improved aesthetics and collapse resistance to the resulting article.

The present invention pertains to a personal respiratory protection device that has a mask body where the support structure has been injection molded onto the filtering structure such that the filtering structure becomes bonded to the support structure.

### BACKGROUND

Respirators are commonly worn over the breathing passages of a person for at least one of two common purposes: (1) to reduce impurities or contaminants from entering the wearer's breathing track; and (2) to protect other persons or things from being exposed to pathogens and other contaminants exhaled by the wearer. In the first situation, the respirator is worn in an environment where the air contains particles that are harmful to the wearer—for example, in an auto body shop. In the second situation, the respirator is worn in an environment where there is risk of contamination to other persons or things—for example, in an operating room or clean room.

Some respirators are categorized as being filtering face-piece respirators because the mask body functions as the respirator filtering mechanism. Unlike respirators that use rubber or elastomeric mask bodies in conjunction with attachable filter cartridges (see, e.g., U.S. Pat. No. RE 39,493 to Yuschak et al.) or insert-molded filter elements (see, e.g., U.S. Pat. No. 4,790,306 to Braun), filtering face-piece respirators have the filter media comprise much of the whole mask body so that there is no need to install or replace a filter cartridge. As such, filtering face-piece respirators are relatively light in weight, easy to use, and disposable.

Filtering face-piece respirators typically include molded shaping layers to support the filtering structure. Examples of patents that disclose such products include U.S. Pat. No. 7,131,442 to Kronzer et al, U.S. Pat. No. 6,923,182 and U.S. Pat. No. 6,041,782 to Angadjivand et al., U.S. Pat. No. 4,873,972 to Magidson et al., U.S. Pat. No. 4,850,347 to Skov, U.S. Pat. No. 4,807,619 to Dyrud et al., U.S. Pat. No. 4,536,440 to Berg, and Des. 285,374 to Huber et al. These shaping layers are generally made of thermally bonded fibers or open-work filamentary meshes that are molded into cup-shaped configurations. More recently, mask bodies have been developed which use transversely extending structural members to support the filter media—see U.S. Patent Publication 2009/0078261A1 to Martin et al.

During use of a filtering face-piece respirator, filtered particulates can accumulate on the exterior surface of the respirator to diminish its permeability. Diminished permeability may result in breathing resistance that, in turn, may lead to the respirator collapsing toward a wearer's face. Efforts have been made to develop filtering face-piece respirators that resist mask body collapse—see, for example, U.S. Pat. No. 6,923,182 to Angadjivand et al. Known approaches to improve collapse resistance have generally relied on adding additional layers to the mask body—such as adhesive layers and shaping layers.

### SUMMARY OF THE INVENTION

The present invention provides a new filtering face-piece respirator that comprises: (a) a harness; and (b) a mask body that comprises (i) a filtering structure and (ii) a supporting frame structure that has been injection molded onto the filtering structure such that the filtering structure becomes bonded thereto.

The present invention also provides a new method of making a filtering face-piece respirator, which method comprises: providing a filtering structure; and injection molding a supporting frame structure onto the filtering structure such that the frame structure becomes bonded thereto.

The new filtering face-piece respirator and method of the present invention differ from known respirators and methods of manufacturing respirators in that the mask body comprises a frame structure that has been injection molded onto the filtering structure such that the filtering structure becomes bonded to the frame structure. Conventional filtering face-piece respirators have used shaping layers that comprise nonwoven fibrous webs or plastic meshes or transversely-extending frame members to support the filter media. Conventional filtering face-piece respirators have not, however, injection molded the supporting frame structure onto the filtering structure to create a bond between these two parts. The present invention allows such a bond to be achieved so that the filtering structure can take on the shape or configuration of the supporting frame structure. According to the present invention, this bond is able to be achieved without damaging or ruining the filtering structure in the process. The result is a respirator that resists collapse and that is aesthetically pleasing in that the filtering structure closely follows the intended configuration of the support structure.

### Glossary

The terms set forth below will have the meanings as defined:

“bonding” and its variations mean to join together;

“centrally spaced” means separated from one another along a line or plane that bisects the mask body vertically when viewed from the front;

“chemical bonding”, “chemical adhesion”, “chemically adhered”, and “chemically bonded” refer to physical processes of adhesion responsible for the attractive interactions between atoms and molecules and includes covalent and ionic bonds (as well as hydrogen and van der Waal's bonds) and can often depend on available functional groups on a surface to be bonded and their reactivity with the material that is selected to be joined thereto so that pretreatment of the surface to be bonded is unnecessary;

“clean air” means a volume of atmospheric ambient air that has been filtered to remove contaminants;

“comprises (or comprising)” means its definition as is standard in patent terminology, being an open-ended term that is generally synonymous with other open-ended terms like “includes”, “has”, and “contains”;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends laterally across the respirator from side-to-side when the respirator is viewed from the front;

“dissimilar materials” refers to materials that have different physical properties;

“exterior gas space” means the ambient atmospheric gas space into which exhaled gas enters after passing through and beyond the mask body and/or exhalation valve;

“filtering face-piece” means that the mask body itself is designed to filter air that passes through it; there are no separately identifiable filter cartridges or inserted molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filtering structure” means a construction that is designed primarily for filtering air;

“first side” means an area of the mask body that is laterally distanced from a plane that bisects the respirator vertically and that would reside in the region of a wearer's cheek and/or jaw when the respirator is being donned;

“harness” means a structure or combination of parts that assists in supporting the mask body on a wearer's face;

“injection molding” means making a solid part from liquid plastic that is forced into a mold cavity and cooled;

“integral” means made at the same time of similar materials;

“interior gas space” means the space between a mask body and a person's face;

“interpenetration” refers to a process of a liquid material penetrating into voids or spaces in a solid material and then solidifying;

“line of demarcation” means a fold, seam, weld line, bond line, stitch line, and/or any combination(s) thereof;

“mask body” means an air-permeable structure that is designed to fit over the nose and mouth of a person and that helps define an interior gas space separated from an exterior gas space;

“member” in relation to the supporting frame structure, means an individually and readily identifiable solid part that is sized to contribute significantly to the overall construction and configuration of the supporting frame structure;

“perimeter” means the outer peripheral portion of the mask body, which outer portion would be disposed generally proximate to a wearer's face when the respirator is being donned by a person;

“polymeric” and “plastic” each mean a material that mainly includes one or more polymers and may contain other ingredients as well;

“plurality” means two or more;

“respirator” means an air filtration device that is worn by a person to provide the wearer with clean air to breathe;

“second side” means an area of the mask body that is distanced from a plane line that bisects the mask vertically (the second side being opposite the first side) and that would reside in the region of a wearer's cheek and/or jaw when the respirator is being donned;

“spaced” means physically separated or having measurable distance therebetween;

“supporting frame structure” means a construction that is designed to have sufficient structural integrity by itself to retain a mask body in its intended three-dimensional shape; and

“transversely-extending” means extending generally in the crosswise dimension.

### BRIEF DESCRIPTION OF THE DRAWINGS

FIG. 1 shows a front perspective view of a filtering face-piece respirator 10 in accordance with the present invention.

FIG. 2 is an enlarged schematic and fragmented cross-sectional view illustrating an example of a filtering structure 18 that may be used in a respirator of the present invention.

FIG. 3 is a digital photomicrograph illustrating bonding between an injection molded supporting frame structure member 26 and a filtering structure 18 according to the present invention.

FIG. 4 illustrates a flow diagram of a process 60 that may be used in connection with the present invention.

FIG. 5 is a schematic plan view of an untrimmed perform 64 used to form a filtering structure for use in connection with making a respirator according to the present invention.

### DETAILED DESCRIPTION

As will be described, the filtering face-piece respirators may be comprised of a mask body that comprises a filtering structure that can have a three-dimensional configuration, in combination with, a supporting frame structure that has been injection molded to the filtering structure. The words “a”, “an,” and “the” may be used interchangeably with “at least one” to mean one or more of the elements being described. For facilitating the following description and when viewing a filtering face-piece respirator, as projected onto a plane, from the front, a transverse dimension extends across the respirator, and a longitudinal dimension extends between the bottom and the top of the respirator.

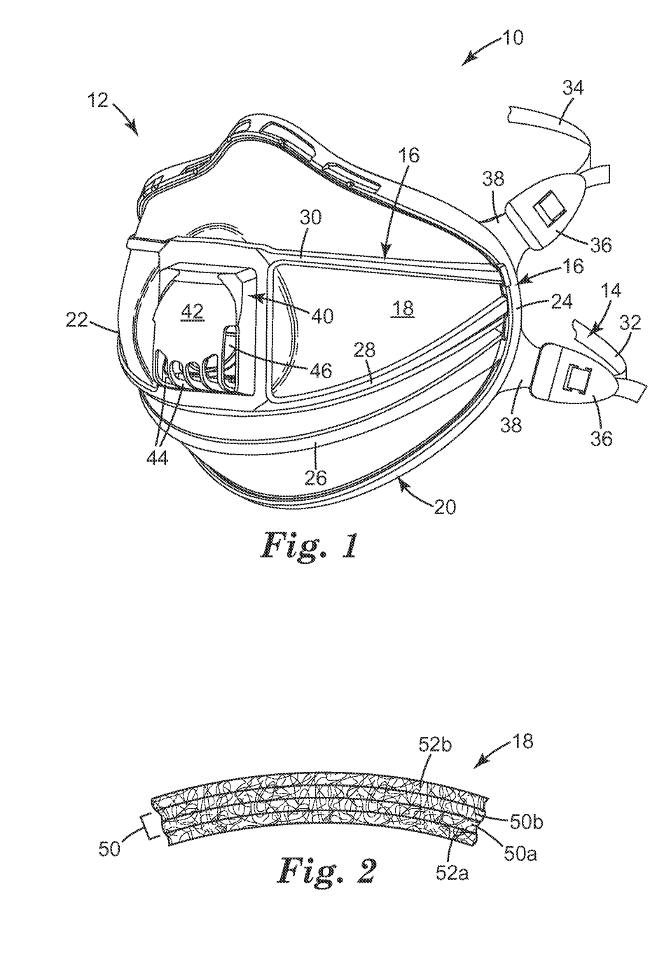

FIG. 1 shows a filtering face-piece respirator 10 that includes a mask body 12 and a harness 14. The mask body 12 has a supporting frame structure 16 and a filtering structure 18. The supporting frame structure 16 has a skeletal configuration relative to the filtering structure 18. The frame structure 16 is bonded to the filtering structure 18 in areas where the filtering structure resides behind the frame structure. The supporting frame structure 16 includes a single piece integrally molded three-dimensional skeletal type construction that may be comprised of a relatively strong structural material(s) that can be flexible or bendable to accommodate various facial shapes. The supporting frame structure is generally comprised of more than a single member, and the members may be joined together in any suitable manner, including an integral one-piece construction. The supporting frame structure 16 may have a wide variety of three-dimensional shapes and sizes based, in part, upon the end use of the filtering face-piece respirator. The three-dimensional configuration of the supporting frame structure 16 may provide a three-dimensional cup-shaped configuration for fitting over a wearer's nose and mouth. Other such three-dimensional configurations are contemplated depending on, for example, the desired end use of the respirator—see, for example, U.S. Pat. 4,827,924 to Japuntich.

The supporting frame structure 16 is injection molded onto the filtering structure 18. The supporting frame structure 16 may include a perimeter portion 20 and a first and second sides 22 and 24. The perimeter portion 20 may be comprised of a single continuous member or may be a combination of members or segments that may extend about 360° about the mask body 12. The user's face may contact only the inner surface of the filtering structure 18 for achieving a comfortable and sealing fit. The supporting frame structure 16 also may comprise a member that extends across the mask body such as a transversely-extending member 26, 28, and/or 30. One or more of the transversely-extending members may expand or contract longitudinally to better accommodate wearer jaw movement and various sized faces—see U.S. Patent Publication 2009/0078261A1 to Martin et al. The generally transversely-extending ribs or members 26 and 28, for example, may extend from the first side 22 to the second side 24 without being joined together therebetween. As such, there is not any longitudinally extending member that might hinder movement of the transversely-extending members 26 and 28 in a longitudinal direction. Stated somewhat differently, there is no structural member that joins the transversely-extending member 26 to the transversely-extending member 28, which restricts movement of these members relative to one another when a user expands their jaw or opens their mouth. The mask body 12 may readily expand and contract, generally longitudinally, in areas between pairs of the longitudinally-movable and generally transversely-extending members 26 and 28 as well as the other transversely-extending members that are not joined together by any structural member. The transversely-extending members 26, 28 and 30 may be rectangular, circular, triangular, elliptical, trapezoidal, etc. when viewed in cross-section and may have, for example, a cross-sectional area of about 2 to 12 mm² or, more typically, about 4 to 8 mm². The supporting frame structure 16 defines a skeletal construction that may be placed on an interior or exterior surface (or both sides) of the filtering structure.

The supporting frame structure 16 may include a living hinge in the perimeter portion 20 located in the region where movable transversely-extending member 26 meets transversely-extending member 28—see U.S. Patent Application 2009/0078262A1 to Gebrewold et al. The living hinge allows the transversely-extending members 26 and 28 to more easily move towards or away from one another.

The supporting frame structure 16 may be made of several known materials. In terms of the materials that may be used, these materials may include several known plastics, such as olefins including, polyethylene, polypropylene, polybutylene, and polymethyl(pentene); plastomers; thermoplastics; thermoplastic elastomers; thermosets, blends or combinations. Additives, such as pigments, UV stabilizers, anti-block agents, nucleating agents, fungicides, and bactericides also may be added. The plastic used may exhibit resilience, shape memory, and resistance to flexural fatigue so that the supporting structure may be deformed many times (e.g., greater than 100), particularly at any hinge points, and return to its original condition. The plastic selected may withstand numerous deformations so that the support structure exhibits a greater service life than the filtering structure. The supporting frame structure may, for example, include a plastic that exhibits a Stiffness in Flexure of about 75 to 300 Mega Pascals (MPa), more typically about 100 to 250 MPa, and still typically about 175 to 225 MPa. The Stiffness in Flexure may be determined according to the Stiffness in Flexure Test set forth in U.S. Patent Application 2009/0078261A1 to Martin et al. The harness 14 may include first and second straps 32 and 34 that may be adjusted in length through the use of one or more buckles 36. The harness 14 may be secured to the mask body 12 at the first and second sides 22, 24 at harness securement flange members 38. The buckles 36 may be secured to the mask body 12 at the flange members 38 by being insert molded thereto. A variety of other methods may be used as well, including stapling, adhesive bonding, welding, and combinations thereof. U.S. Patent Application Publication US2009/0078266A1 to Stepan describes a mask body that has buckles that are integrally molded into the supporting frame structure. The mask body 12 also may include an exhalation valve 40 that purges exhaled air from the mask interior to improve wearer comfort. The exhalation valve 40 may be joined to the mask body 12 by any suitable approach such as adhesive bonding, heat bonding, sonic and laser welding, mechanical clamping, and combinations thereof. See, for example, U.S. Pat. No. 7,069,931 to Curran et al. and U.S. Patent Application Publication US2009/0078264A1 to Martin et al. The exhalation valve 40 also includes a valve cover 42 that resides over a valve seat to define an air chamber through which exhaled air passes before exiting the valve 40 at the valve cover opening(s) 44. The exhalation valve 40 may include a flexible flap 46 that lifts from the valve seat in response to exhalation pressure generated by a wearer during exhalation.

FIG. 2 illustrates an example of a filtering structure 18 that may be used in connection with a respirator of the present invention. The filtering structure 18 may include a filter media 50 in the form of at least one filtration layer 50a, 50b and also include inner and outer cover layers or webs 52a, 52b, respectively. Essentially any material that is suitable for use as a respirator filter media may be used in the filtering structure. Generally, the shape of the filtering structure 18 may correspond to the general shape of the supporting frame structure so that the two structures can be readily joined together. The material(s) selected for the filtering structure 18, particularly filter media 50, may depend upon the kind of substances to be filtered. For example, the filtering structure 18 can be of a particle capture or gas and vapor type filter. The filtering structure 18 also may act as a barrier layer that reduces the liquid transfer from one side of the filter layer to another to reduce, for instance, liquid aerosols or liquid splashes from penetrating the filter layer. Multiple layers of similar or dissimilar filter media may be used to construct the filtering structure of the present description, as the application requires. Filters that may be beneficially employed in a layered mask body of the present invention are generally low in pressure drop (for example, less than about 200 to 300 Pascals at a face velocity of 13.8 centimeters per second) to minimize the breathing work of the mask wearer. The filtration layers additionally are generally flexible and have sufficient shear strength so that they generally retain their structure under expected use conditions.

The filtering structure typically is adapted to properly fit against or within the supporting frame structure. The filtering structure may be disposed inwardly from the supporting frame structure, it may be disposed outwardly of the supporting frame structure, or it may be disposed between various members that comprise the supporting frame structure. The filtering structure also may use pre-filters. Additionally, the filtering structure may include materials, such as sorptive materials including activated carbon disposed between the fibers and/or various layers that comprise the filtering structure for removing hazardous or odorous gases from the breathing air—see U.S. Pat. No. 3,971,373 to Braun. An example of sorptive filtration structure that may be conformed into various configurations is described in U.S. Pat. No. 6,391,429 to Senkus et al. The filtering structure may include more than one filtration layer and may be used in conjunction with the sorptive layers to provide filtration for both particulates and vapors. Examples of particle capture filters include one or more webs of polymeric synthetic fibers or fine inorganic fibers such as fiberglass. Synthetic fiber webs may include electret charged polymeric microfibers that are produced from processes such as meltblowing. Polyolefin microfibers formed from polypropylene that has been electrically charged provide particular utility for particulate capture applications.

As indicated, the filtration layer(s) may come in a variety of shapes and forms. Typically, the filter media may have a thickness of about 0.2 millimeters (mm) to 1 centimeter (cm), more typically about 0.3 mm to 0.5 cm, and it could be a generally planar web(s) or it could be corrugated to provide an expanded surface area—see, for example, U.S. Pat. Nos. 5,804,295 and 5,656,368 to Braun et al. The filter media also may include multiple filtration layers joined together by an adhesive or any other means. Webs of melt-blown fibers, such as those taught in Wente, Van A., Superfine Thermoplastic Fibers, 48 Indus. Engn. Chem., 1342 et seq. (1956), especially when in a persistent electrically charged (electret) form is especially useful—see, for example, U.S. Pat. No. 4,215,682 to Kubik et al. These melt-blown fibers of each layer may be microfibers that have an effective fiber diameter less than about 20 micrometers (μm) (referred to as BMF for “blown microfiber”), typically about 1 to 12 μm. Effective fiber diameter may be determined according to Davies, C. N., The Separation of Airborne Dust Particles, Institution Of Mechanical Engineers, London, Proceedings 1B, 1952. One exemplary embodiment may include BMF webs that contain fibers formed from polypropylene, poly(4-methyl-1-pentene), and combinations and blends thereof. Electrically charged fibrillated-film fibers as taught in van Turnhout, U.S. Pat. No. Re. 31,285 also may be suitable, as well as rosin-wool fibrous webs and webs of glass fibers or solution-blown, or electrostatically sprayed fibers, especially in microfilm form. Electric charge can be imparted to the fibers by contacting the fibers with water as disclosed in U.S. Pat. No. 6,824,718 to Eitzman et al., U.S. Pat. No. 6,783,574 to Angadjivand et al., U.S. Pat. No. 6,743,464 to Insley et al., U.S. Pat. Nos. 6,454,986 and 6,406,657 to Eitzman et al., and U.S. Pat. Nos 6,375,886 and 5,496,507 to Angadjivand et al. Electric charge also may be imparted to the fibers by corona charging as disclosed in U.S. Pat. No. 4,588,537 to Klasse et al. or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment—see U.S. Pat. Nos. 6,398,847 B1, 6,397,458 B1, and 6,409,806 B1 to Jones et al. Typical basis weights for electret BMF filtration layers are about 10 to 100 grams per square meter. When electrically charged according to techniques described in, for example, the '507 patent, and when including fluorine atoms as mentioned in the Jones et al. patents, the basis weight may be about 20 to 40 g/m² and about 10 to 30 g/m², respectively. The respirator filter media may be formed from two layers of standard 3M 8511 N 95 respirator electrate filter material (having a fiber diameter in a range of about 6 to 12 micrometers) laminated between one 50 grams per square meter (gsm) outer layer white nonwoven spunbond and one inner layer 22 gsm white Nonwoven spunbond material. Both the layers of nonwoven spunbond materials may have fiber diameters of about 8 to 12 micrometers, obtained from Fiberweb Washougal Inc. 3720 Grant Street, Washougal, Wash. 98671.

The inner cover web can be used to provide a smooth surface for contacting the wearer's face, and the outer cover web can be used to entrap loose fibers in the mask body or for aesthetic reasons. The cover webs typically do not provide any substantial filtering benefits to the filtering structure, although it can act as a pre-filter when disposed on the exterior (or upstream to) the filtration layer. To obtain a suitable degree of comfort, an inner cover web may have a comparatively low basis weight and may be formed from comparatively fine fibers. More particularly, the cover web may be fashioned to have a basis weight of about 5 to 50 g/m² (typically 10 to 30 g/m²). The fibers typically have a denier of less than 3.5, (more typically less than 2 denier, and still more typically less than 1 denier but greater than 0.1). Fibers used in the inner cover web often have an average fiber diameter of about 5 to 24 micrometers, typically of about 7 to 18 micrometers, and more typically of about 8 to 12 micrometers. The inner cover web material may have a degree of elasticity (typically, but not necessarily, 100 to 200% at break) and may be plastically deformable. Suitable materials for the cover web are blown microfiber (BMF) materials, particularly polyolefin BMF materials, for example polypropylene BMF materials (including polypropylene blends and also blends of polypropylene and polyethylene). A suitable process for producing BMF materials for a cover web is described in U.S. Pat. No. 4,013,816 to Sabee et al. The cover web may be formed by collecting the fibers on a smooth surface, typically a smooth-surfaced drum. Spun-bond fibers also may be used.

Typical cover webs may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material after, for example, ultrasonic welding by the layers. Polyolefin materials that are suitable for use in a cover web may include, for example, a single polypropylene blend of two polypropylenes, and blends of polypropylene and polyethylene, blends of polypropylene and poly (4-methyl-1-pentene), and/or blends of polypropylene and polybutylene. One example of a fiber for an outer cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Fibers used in the outer cover web often have an average fiber diameters similar to the inner cover web. Another suitable fiber is a polypropylene/polyethylene BMF (produced from a mixture comprising 85 percent of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available, under the trade designations “Corosoft Plus 20”, “Corosoft Classic 20” and “Corovin PP-S-14”, from Corovin GmbH of Peine, Germany, and a carded polypropylene/viscose material available, under the trade designation “370/15”, from J. W. Suominen OY of Nakila, Finland. The cover webs that are used in the present invention may have very few fibers protruding from the cover web surface after processing and therefore have a smooth outer surface. Examples of cover webs that may be used in the present description are disclosed, for example, in U.S. Pat. No. 6,041,782 to Angadjivand, U.S. Pat. No. 6,123,077 to Bostock et al., and WO 96/28216A to Bostock et al.

The present invention contemplates injection molding a conformable three-dimensional supporting frame structure to a three-dimensional filtering structure in such a manner as to provide a bond between the support structure and the filtering structure. The bonding may be sure and reliable and may include mechanical interpenetration of the supporting frame material to the web(s) of the filtration structure 18, as well as any chemical bonding or adhesion that may result in addition to or in lieu of the mechanical bonding. The mechanical and/or chemical bonding or adhesion may result from the partial or complete melting of the fibers of, for example, the outer cover web and at least one of the filtration layers of the present filtering structure.

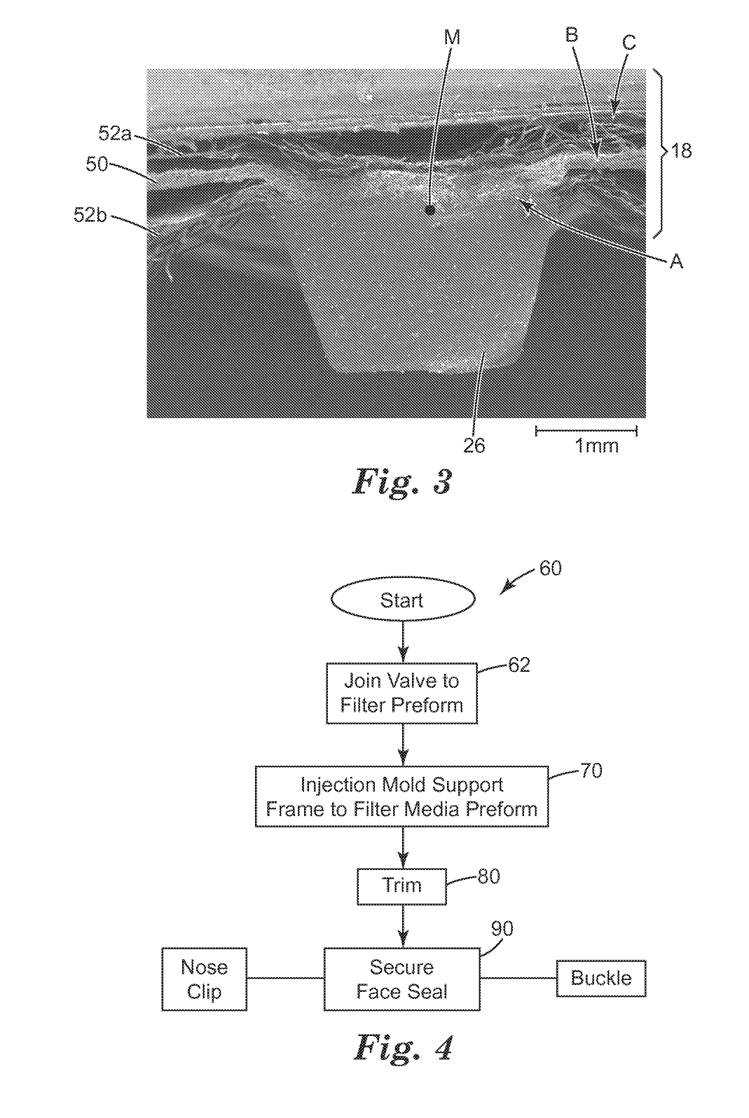

FIG. 3 shows a digital photomicrograph that illustrates one example of the bonding that may occur. The illustrated cross section was taken through the injection molded frame on a sample that was prepared by cutting through the bonded area using a sharp scalpel blade at room temperature. The cross-section was made on the sample through the transversely-extending member 26 towards the center of the mask body. As shown, mechanical interpenetration of the filtration structure 18 as well as enhanced bonding arising from the compression of the various layers of the filtration structure was achievable. This mechanical interpenetration type of bonding adds to the strength provided by any chemical bonding or chemical adhesion that may occur. The fiber layers of the outer cover web 52b, represented approximately in Zone A, may be almost completely melted; the filtration layer 50, represented approximately in zone A, may be partially melted, while a portion of the filtration layer 50, represented approximately in Zone B, has been mechanically interpenetrated by the molten plastic forming the structuring frame material. In this embodiment, the degree of interpenetration may be through part or all the layers of the filtration layer 50. Stated differently, the degree of interpenetration may be all or some part of the thickness of the filtration layer 50. The depth of the penetration, for example may range from about 0.5 micrometers to about 400 micrometers, and more typically from about 5 to 300 micrometers. The inner cover web 52a, represented by Zone C did not appear to have been interpenetrated by the molten plastic to any significant extent. By controlling the molding to not interpenetrate the inner cover web 52a, improved aesthetics can be achieved because the plastic will not otherwise adversely affect or be visible from the surface finish of the mask body 12 (FIG. 1). Although, the present invention envisions allowing the molten plastic to penetrate through portions of the entire filter structure 18, various changes may be made regarding the degree of mechanical interpenetration, such as by controlling the interpenetration depth in each layer or combination of layers of a filtration structure. Bonded injection molding as practiced, compresses fibers in the filtering structure so as to further promote good bonding. Injection molding pressures may be varied to achieve the foregoing ends of compression and interpenetration that results in an improved mechanical connection or interlock between the support structure and the filtering structure. The injection molding pressures, as carried out in the present invention, not only typically cause mechanically interpenetration, but they may also compress the outer cover web 52b and the filtration layers 50 to further enhance the overall bonding therebetween. Some degree of melting of the inner cover web 52a and filtration layers 50 may result, but it is not as pronounced as the melting that occurs with respect to the outer cover web and the outer filtration layers. Enhanced bonding improves the separation resistance between the filtration structure and the supporting frame structure. Aesthetics may be improved by a continuous and generally uniform bonding along the surface of the filtering structure 18 without extending beyond or through the surface of the inner cover web 52a.

In the present invention, the members that are injection molded onto the filtering structure may be bonded thereto substantially along lines of demarcation in the filtering structure. A continuous bond may provide a more durable connection than a separated or non-continuous bond, thereby better resisting separation. A continuous bond also may provide an enhanced aesthetic appearance that may provide commercial advantages. The members of the supporting frame structure also may be bonded to the filtering structure substantially along the mask body perimeter. Injection molding may be carried out in such a manner, whereby conditions of injection pressure, mold clamp force, temperature, and cycle time, for example, may be controlled to affect not only a chemical bonding and/or adhesion of those layers that may be melted or partially melted, but provides for mechanical interpenetration or interlock of at least the fibers of the filtration layer not melted as noted above. The temperatures for injection molding may melt the outer web cover layer as well one or more of the filtration layers, such as an outer filtration layer and some of an inner filtration layer. Interpenetration may be carried out to a depth that ranges generally from where the melting ends, at, for example, point M at least up to and/or through a portion of the inner web cover 52a. As noted, the inner web cover 52a is not completely penetrated so that the injection molded plastic is not visible when viewing the mask body from the rear. Other interpenetration depths may be obtained for affecting the mechanical interpenetration or anchoring depending on a number of factors, including the number of fiber layers, the average fiber diameters, the size of asperities in the fiber layers, and the injection pressure, mold clamp force, and temperature of the liquid material during molding. Because of aesthetic concerns and other requirements as noted, the present illustrated embodiment does not have the supporting structure penetrate the inner web cover 52a so as to be visible from the opposing side of the filtering structure.

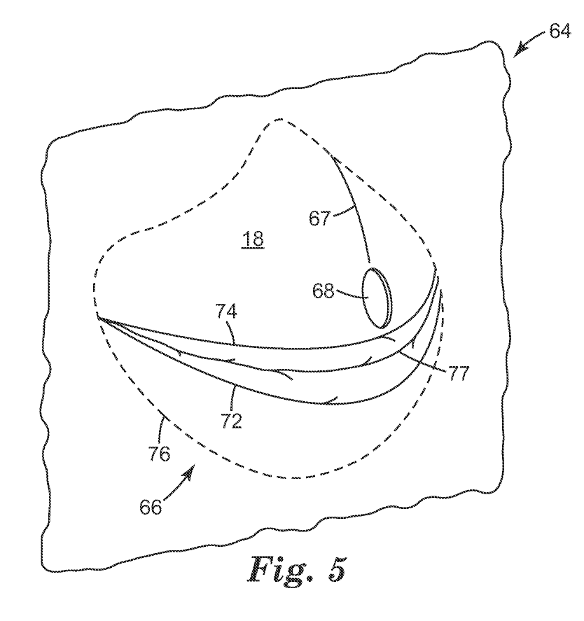

FIG. 4. shows a method 60 of making a respirator where the supporting frame structure is secured to the filtering structure. The filtering structure may be provided by manufacturing it, purchasing it, having it made, etc. In step 62, an exhalation valve may be joined to the filter media or filtration structure preform. The exhalation valve may be attached to the mask body to facilitate purging exhaled air from the interior gas space. The use of an exhalation valve may improve wearer comfort by rapidly removing the warm moist exhaled air from the mask interior—see, for example, U.S. Pat. Nos. 7,188,622, 7,028,689, and 7,013,895 to Martin et al.; U.S. Pat. Nos. 7,428,903, 7,311,104, 7,117,868, 6,854,463, 6,843,248, and 5,325,892 to Japuntich et al.; U.S. Pat. No. 6,883,518 to Mittelstadt et al.; and U.S. Pat. No. RE 37,974 to Bowers. Essentially any exhalation valve that provides a suitable pressure drop and that can be properly secured to the mask body may be used in connection with the present invention to rapidly deliver exhaled air from the interior gas space to the exterior gas space. The filter media or filtration structure preform may be made using the filtering structure materials/layers described above. The preform may include a blank 64 (FIG. 5) of the filtration material, the shape of which may vary depending on the respirator configuration intended to be made. The preform blank, after being dispensed from a typical preform blank roll, may be cut into an untrimmed article 66 (FIG. 5) that exceeds the size of the respirator. A vertical cut 67 may be provided in the untrimmed article 66 to eliminate excess material and to provide a cup shape. The optional exhalation valve is joined to the untrimmed preform blank 64 at the opening 68.

In step 70 a supporting frame structure is molded onto the filtering structure of the preform blank 64. The supporting frame structure may be injected molded so as to form a continuous or semi-continuous bond to the demarcation lines 72 and 74 of the filtering structure. In addition, a perimeter portion of the supporting frame structure may be bonded to the periphery 76 of filtering structure 18. The injection molding may be performed to achieve a bonding layer that may include melted and partially melted fabric of the filtration layer and some form of mechanical interpenetration of the fibers of the filtration layer. As noted above, this type of bonding may include a mechanical interlock or connection that may provide for a relatively strong joint having enhanced durability. A pleat line 77 may be provided in the shaped filtering structure 66 to accommodate mask body expansion.

In one mode, the untrimmed filtering structure 64 may be placed on the core of a first horizontal mold half in a vertical or horizontal press. Appropriate registration between the first mold core and the filtering structure and exhalation valve may be achieved using an alignment system. The filtering structure and exhalation valve may be retained in position, for example, by gravity, and retaining reference features on the valve or support structure. A second half has a cavity that may be used which has a shape and size that is a negative of the shape of the combined filtering structure, supporting frame, and exhalation valve. The supporting frame structure may be injection molded onto the outside or exterior major surface of the filtering structure, whereby the resulting structure may be similar to that viewed, for example, in FIG. 1. Alternatively, the supporting frame structure may be injection molded onto interior portions of the filtering structure or on both sides of the filtering structure.

Following registration, liquid plastic is injected into the second mold cavity in an injection pressure range and in a temperature range and for a timing cycle to bring about the desired mechanical interpenetration of the plastic of the supporting frame structure with the permeable structure of filtering structure. Various parameters may be used for controlling an injection molding process depending on, for example, the materials and amounts used. Typical parameters may include clamp tonnage for clamping the mold halves together, cooling times, temperatures, and injection pressure that the liquid plastic is injected into the second mold cavity.

The materials used for the supporting frame structure may be selected from the grouping of materials identified earlier. The materials of the supporting frame structure and the filtering structure, as well as other components, may be the same or may be dissimilar. The temperatures, injection pressures, and curing times selected for molding vary and may depend, in part, on the materials to be molded together. For a plastic support structure that comprises polypropylene, the injection temperatures may be about 150 to 250 ° C. The mold clamp force may vary from about at least 50 tons, and more typically from about 60 tons to about 140 tons for a vertical press mold, while the temperature of the liquid plastic may vary based on the plastic material being used to form the supporting frame structure. The timing cycle also may vary, for example, depending on the materials being used.

In step 80, the untrimmed portion of the preform blank 64 extending beyond the perimeter of the supporting frame structure may be cut using an appropriate a trimming device. In one example, the untrimmed portion of the preform component material may be removed after being placed in a die. A blade trimming device may cut or trim the overhanging portion of the perimeter that extends laterally beyond the filter media periphery 76. A wide variety of other techniques also may be used to trim the excess material, such as lasers, hot wires, and the like.

In step block 90, a face seal element may be secured to the periphery of the supporting frame structure. The filtering face-piece respirator may have the face seal element added thereto by overmolding it to the perimeter of the supporting frame structure. The face seal also could be molded, contact molded, liquid injection molded, or the like—see U.S. patent application ______ entitled Filtering Face Piece Respirator Having An Overmolded Face Seal filed on the same day as this patent application (attorney case number 64755US002). A nose clip and a plurality of buckles of the kinds noted above also may be generally simultaneously secured to the supporting frame structure. The locations of the nose clip and the buckles may be as described above or at other locations consistent with good practice in the respirator field. The nose clip can be mounted in a cavity for holding the nose clip and may be over molded when the face seal element is molded onto the supporting frame structure.

A nose clip that is used in conjunction with the present invention may be essentially any additional part that assists in improving the fit over the wearer's nose. Because there are substantial changes in contour to the wearer's face in this region, a nose clip can better assist the mask body in achieving the appropriate fit in this location. The nose clip may comprise, for example, a pliable dead soft band of metal such as aluminum, which can be shaped to hold the mask in a desired fitting relationship over the nose of the wearer and where the nose meets the cheek. An example of a suitable nose clip is shown in U.S. Pat. No. 5,558,089 and Des. 412,573 to Castiglione. Other nose clips are described in U.S. patent application Ser. No. 12/238,737 (filed Sep. 26, 2008); U.S. Publications 2007-0044803A1 (filed Aug. 25, 2005); and 2007-0068529A1 (filed Sep. 27, 2005).

### EXAMPLES

### Respirator Filtering Structure

A respirator filtering structure preform as shown in FIG. 5 may be prepared in a manner similar to the method described in U.S. Patent Application 2009/0078261 to Martin et al. The respirator filtering element or structure, prior to molding, was an untrimmed preform, formed from two 254 millimeter (mm) wide layers of standard 3M 8511 N 95 respirator electret between a 50 grams per square meter (gsm) outer layer of white nonwoven spunbond and an inner layer of 22 gsm white nonwoven spunbond material. Both spunbond cover web layers were made of polypropylene and were supplied by Fiberweb Washougal Inc, 3720 Grant Street, Washougal, Wash. 98671.

### Injection Molding Support Structure

Samples of a respirator supporting structure were injection molded onto the filtering structure using a standard injection molding process. Single cavity male and female mold halves were formed, which had a geometry similar to the support structure shown in FIG. 1. The mold configurations allowed the filtering structure to be placed over the male part of the mold and held in place before molding. The mold design also included a clearance between the male and female parts of the mold to compensate for filtering structure thickness.

Injection molding of the parts was done on a 154 ton FN 3000 NISSEI Injection Molding Press (available from Nissei America Inc., of Anaheim, Calif.) using process conditions listed in Table 1 below. In these examples, four different prototypes were made using the following resin materials.
1. 100% Monoprene 1249D from Teknor Apex, Pawtucket, R.I.;
2. 50% Monoprene 1249D and 50% Monoprene 1337A from Teknor Apex, Pawtucket, Rhode Island;
3. 50% Elastocon 2825 and 50% Elastocon 2810 from Elastocon TPE Technologies, Rochester, Ill.; and
4. 100% Polypropylene 7823 from Total Petrochemicals, USA, Inc., Houston Tex.
   After molding at a relaxed state or while the support structure was still on the mold, the support structure measured 115 mm top to bottom and 120 mm from side to side. The targeted thickness of the structure was 2.5 millimeters.

TABLE 1
Support Structure Injection Molding Process Conditions

| | Example | | | |
|---|---|---|---|---|
| Process Condition | 1 | 2 | 3 | 4 |
| Material | 100% MP- | 50% MP- | 50% | 100% |
| | 1249D | 1249D, 50% | Elastocon | PP7823 |
| | | MP-1337A | 2825/50% | |
| | | | Elastocon | |
| | | | 2810 | |
| Cycle time (not | 35 | 32 | 36 | 32 |
| including placing | | | | |
| filtering element in to | | | | |
| mold) (Seconds) | | | | |
| Injection time | 11 | 9 | 13 | 8.3 |
| (Seconds) | | | | |
| Fill Time (Seconds) | 3 | 3 | 3 | 3 |
| Cooling Time | 20 | 20 | 20 | 20 |
| (Seconds) | | | | |
| Mold Clamp Force | 115 | 123 | 62 | 139 |
| (Tons) | | | | |
| Barrel temperature | 210 | 210 | 210 | 210 |
| (nozzle, front, center | | | | |
| and rear) (° C.) | | | | |

In each of the above examples, the plastic material mechanically penetrated and interlocked to at least one of the filtration layers, while not penetrating into or through the inner web cover layer. The filter structure was adequately bonded to the support structure.

This present invention may take on various modifications and alterations without departing from its spirit and scope. Accordingly, this present invention is not limited to the above-described embodiments but is to be controlled by limitations set forth in the following claims and any equivalents thereof. This present invention also may be suitably practiced in the absence of any element not specifically disclosed herein. All patents and publications cited above, including any in the Background section, are incorporated by reference into this document in total. To the extent that there is a conflict with the present document, this description will control.

What is claimed is:

1. A filtering face-piece respirator that comprises:
a) a harness; and
b) a mask body that comprises:
(i) a filtering structure; and
(ii) a supporting frame structure that has been injection molded onto the filtering structure such that the filtering structure becomes bonded thereto.

2. The filtering face-piece respirator of claim 1, wherein the injection molded supporting frame structure and the filtering structure are bonded by at least one of mechanical interpenetration and chemical adhesion.

3. The filtering face-piece respirator of claim 1, wherein the injection molded supporting frame structure does not penetrate into a first major surface of the filtering structure so as to be visible from an opposing second major surface where the frame structure is bonded to the filtration structure.

4. The filtering face-piece respirator of claim 3, wherein there is a continuous bond at interfaces between the injected molded supporting frame structure and the filtering structure.

5. The filtering face-piece respirator of claim 4, wherein the filtering structure is compressed at the continuous bond by injection molding of the supporting frame structure thereto.

6. The filtering face-piece respirator of claim 1, wherein the supporting frame structure has a skeletal configuration that comprise members that have a cross-sectional area of 2 to 12 square millimeters.

7. The filtering face-piece respirator of claim 2, wherein the depth of mechanical interpenetration is at least partially throughout a portion of the thickness of the filtering structure.

8. The filtering face-piece respirator of claim 2, wherein the filtering structure includes first and second cover layers, and at least one filtration layer interposed between the first and second cover layers, wherein the at least one filtration layer has been mechanically interpenetrated by the injection molded supporting frame structure.

9. The filtering face-piece respirator of claim 8, wherein at least one of the first and second cover layers has been chemically bonded with corresponding portions of the injection molded supporting frame structure.

10. The filtering face-piece respirator of claim 1, wherein the supporting frame structure includes a perimeter portion and one or more generally transversely-extending members that define supporting portions of the supporting structure.

11. The filtering face-piece respirator of claim 1, wherein the filtering structure comprises one or more cover webs where at least one cover web is an outer cover web, and one or more filtering layers, and wherein the mask body comprises at least one transversely extending member that is bonded to the outer cover web and to at least one of the filter layers.

12. A process for making a filtering face-piece respirator, which process comprises:
(a) providing a filtering structure; and
(b) injection molding a supporting frame structure onto the filtering structure such that the supporting frame structure becomes bonded thereto.

13. The process of claim 12, wherein the injection molding forms a continuous bonded joint at interfaces between the supporting frame structure and the filtering structure.

14. The process of claim 12, wherein the injecting molding of the supporting frame structure to the filtering structure includes bonding by at least one of mechanical interpenetration and chemical adhesion.

15. The process of claim 12, wherein the filtering structure comprises filter media that contains a plurality of layers, and wherein the support structure is bonded to at least one of the layers.

16. The process of claim 12, wherein the injection molding of the supporting frame structure is carried out so as not to generally penetrate through all layers of the filter media.

17. A process for making a filtering face-piece respirator, which process comprises:
injection molding a supporting frame structure that comprises at least one member that extends at least partially across the mask body onto a filtering structure that comprises an outer cover web and a filtering layer, wherein the injection molding step causes the member to be bonded to the outer cover web and to at least part of the filtering layer.

18. The process of claim 17, wherein the member is a transversely extending member that becomes continuously bonded to the filtering structure.

19. The process of claim 17, wherein the mold clamp force is carried out at pressure of at least 50 tons.

20. A filtering face-piece respirator that comprises:
a) a harness that includes one or more straps; and
b) a mask body that has the harness joined thereto and that comprises:
(i) a filtering structure that contains one or more layers of electrically-charged nonwoven fibrous material and one or more cover webs which each contain polymeric fibers; and
(ii) a plastic supporting frame structure that includes at least one member that extends across the mask body and that has been injection molded onto the filtering structure such that the at least one member becomes bonded to the filtering structure by having the plastic of the support structure member interpenetrate into at least the cover web and at least the one filtering layer.
